(19) United States
(12) Patent Application Publication
(10) Pub. No.: US 2005/0146073 A1
(43) Pub. Date: Jul. 7, 2005

(54) Method for forming a decorative flower pot

(76) Inventor: Aldo Y. Guloy, Manila (PH)

Correspondence Address: Richard C. Litman;LITMAN LAW OFFICES, LTD., P.O. Box 15035, Arlington, VA, 22215, US

(21) Appl. No.: 10/749,523

(22) Filed: Jan. 2, 2004

(51) Int. Cl. B29C 51/10; B29C 59/00

(52) U.S. Cl. 264/132; 264/553; 264/293; 156/219

(57) ABSTRACT

A method of forming a decorative design on the peripheral outer surface of a plastic flower pot. A plastic flower pot having an embossed decoration disposed on the outer peripheral surface thereof is vacuum formed within a mold having an embossed decoration disposed on the peripheral outer surface of the mold. A second method, forming an undistorted image on the outer peripheral surface of a flower pot formed by straight vacuum, includes bonding a decorative wrapper to the outer peripheral surface of a straight vacuum formed flower pot. A third embodiment pre-distorts an image formed on a sheet of plastic, which when stretched and distorted by the vacuum process, produces a flower pot having an undistorted image disposed on the outer peripheral surface of the flower pot.

### BACKGROUND OF THE INVENTION

1. Field of the Invention

The present invention relates to flower pots. More specially, the invention relates to flower pots having a decoration on the outer peripheral surface of the flower pot.

2. Description of the Related Art

Flower pots and flower pot holders having decorations disposed thereon are well known in the field. U.S. Patent Publication No. 2003/0116268, published June 2003, discloses a method of wrapping a pot with a cover having adhesive or cohesive disposed thereon. The application discloses an adhesive and material dispenser for dispensing single sheets of material from stacks of sheets of material or from rolls of material and applying an adhesive to the sheet.

U.S. Patent Publication No. 2003/0172587, published September 2003, discloses a method for forming a decorative cover for a flower pot with a sheet of material having printed and embossed patterns disposed thereon. However, as in the '268 application, the '567 application teaches a cover to a flower pot and not the flower pot itself.

A method and apparatus for the injection molding of elongated cylindrical articles is disclosed in U.S. Pat. No. 3,397,266, issued to Ralph E. Ayres in August 1968. The device discloses a method of reducing mandrel deflection during the molding operation by injecting plastic on the axis of generation at the bottom and causing the mandrel and mold to define a restriction at the base of the cavity so that the material being injected exerts a radially outward pressure on the mandrel which significantly overcomes the tendency of the mandrel to deflect.

U.S. Pat. No. 4,170,618, issued to R. Adams in October 1979, disc loses a decorative container for holding a flower pot, the container being formed by arranging a sheet of plastic polymer upon a form, the form having a shape generally desired for the sheet after it has been molded. The sheet-covered mold is placed within a heater, with the temperature of the heater being warmed to a temperature necessary to soften and fold the plastic sheet about the form. As in the '268 application and the '567 application, the device described in this patent is designed to provide a cover for a flower pot, not the flower pot itself.

U.S. Pat. No. 4,170,622, issued to A. Uhlig in October 1979, disclose a method for reinforcing hollow articles blow molded from a heated plastic material. A hollow parison is formed with concave grooves in its exterior surface at locations in which the finished article is to be reinforced. The parison is then blow molded into the finished article. The blowing pressure and the temperature of the plastic material collapse and fuse the concave grooves to form solid reinforcement ribs located inside the article, while the exterior of the article has a rib-free surface defined by the blow mold.

U.S. Pat. No. 4,467,994, issued to J. Sorenson in August 1984, discloses a mold having a number of circumferential throttles, the throttles having shorter throttle distances than prior designs, which improves the rigidity of the molded thin-walled hollow product.

U.S. Pat. No. 5,228,934, issued to Weder et al., in July 1993, discloses a method of forming a sheet of material into a flower pot or flower pot cover, the method including means for forming pleats in the skirt and/or base of the flower pot.

U.S. Pat. No. 5,577,988, issued to Weider et al. in November 1996, discloses an apparatus and method for forming a sheet of material into a flower pot or flower pot cover with fins. The apparatus includes a male mold, a female mold having an opening mating with the male mold, and means for moving the male mold into and out of the opening of the female mold with the sheet of material between the two molds. To form outwardly extending fins in the flower pot cover, fingers are extended from the male mold to push folds in the sheet of material between segments of the female mold.

U.S. Pat. No. 5,725,468, issued to Weder et al., in March 1998, discloses an apparatus and method using vacuum to form a flat-paneled flower pot or flower pot cover. The method of the '468 patent includes a male die, a female die, air pressure and vacuum to form a sheet of material into a flat-paneled flower pot or flower pot cover. A platform supports the female die, which has an opening with flat surfaces for forming panels in the base and skirt of the flower pot or flower pot cover. The male die has forming surfaces, which mate with the forming surfaces of the female die. The sheet of material is centered over the opening of the female die. A bracket having a plurality of legs, which aligns with the panel-forming surfaces of the female die, is placed on the sheet of material. Air pressure directed through vacuum lines in the opening of the female die is used to control the sheet of material as the male die enters the opening of the female die. The top surface of the platform and the bracket legs provide additional control of the sheet of material. The sheet of material is pressed between forming surfaces of the male and female die to form the flat-paneled flower pot or flower pot cover.

U.S. Pat. No. 5,820,712, issued to Weder et al. in October 1998, discloses a material dispenser for dispensing single sheets of material from stacks of sheets of material or from rolls of material and applying an adhesive strip to the sheet. The adhesive strip is applied by contacting the adhesive portion of an adhesive transfer tape to the sheet. The sheet of material with the adhesive strip applied thereto can be used to wrap floral arrangements, flower pots, or other articles. The apparatus may be combined with an automatic pot wrapping apparatus so that the adhesive application and decorative pot wrapping sequence can be combined into one continuous operation.

Finally, U.S. Pat. No. 5,839,255, issued to Weder in November 1998, discloses a method of forming a preformed pot cover for a flower pot having a three-dimensional printed pattern thereon wherein the three-dimensional pattern is produced by application of a foamable ink composition.

None of the above inventions and patents, taken either singly or in combination, is seen to describe the instant invention as claimed. Thus a flower pot solving the aforementioned problems is desired.

### SUMMARY OF THE INVENTION

The present invention is a method of forming a decorative design on the peripheral outer surface of a plastic flower pot. A plastic flower pot having an embossed decoration disposed on its outer peripheral surface is vacuum formed within a mold having an embossed decoration disposed on the inner surface of the mold. A plastic sheet is placed over the opening of a mold cavity, and then heated. When the plastic is soft and pliable, a vacuum removes the air from the inside of the cavity, drawing the plastic down and against the inside walls of the mold, forming a flower pot with an embossed outer surface. The vacuum formed flower pot may have a plurality of sides and contours, thereby providing the pot with added structural rigidity.

Because vacuum forming results in stretching and distortion of any design disposed on the surface of the plastic prior to vacuum forming, a method of decorating the peripheral surface of a vacuum-formed flower pot is desirable. One method includes bonding a decorative wrapper to the outer peripheral surface of a vacuum formed flower pot. The pot may have smooth walls or may be embossed. If embossed, the decorative wrapper preferably has a matching embossed design to facilitate bonding.

Another method solving the distortion effects of vacuum molding entails pre-distorting the image formed on the sheet of plastic to be vacuum formed. By taking a desired image and pre-distorting it based upon the distortion characteristics of the vacuum forming process, the design, when stretched, produces a flower pot having a decoration that, although not perfect, is a good deal less distorted than if the image was not compressed.

Accordingly, it is a principal object of the invention to form a flower pot having a decorative design using vacuum forming.

It is another object of the invention to form a flower pot having an embossed design on its outer peripheral surface using a vacuum forming method.

It is a further object of the invention to form an embossed plastic flower pot having a structural integrity greater than smooth-walled plastic flower pots.

Still another object of the invention is to form a plastic flower pot having a decorative outer wrapper.

It is another object of the invention to form a plastic flower pot having a decorative design on its outer peripheral surface that is not distorted by the vacuum forming process.

It is another object of the invention to form a decorative design on a vacuum formed flower pot by placing a pre-distorted image of the desired design on a plastic sheet that is to be vacuum formed into a flower pot.

Still another object of the invention is to create a radial matrix on a plastic sheet from which a flower pot is formed having a clear template defining the distortion characteristics of the vacuum forming process.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a front perspective view of a flower pot having an embossed design on its outer peripheral surface.

FIG. 1B is a front perspective view of a flower pot having a plurality of sides.

FIG. 1C is a front perspective view of a flower pot formed in the shape of a star.

FIG. 2A is a front section view of a flower pot mold cavity having an embossed design on its interior surface and a plastic sheet ready to be vacuum formed according to the present invention.

FIG. 2B is a front section view of the mold of FIG. 2A after vacuum has been applied, the embossed flower pot being formed against the interior surface of the mold according to the present invention.

FIG. 2C is a section view of a plastic flower pot according to the present invention removed from the flower pot mold of FIGS. 2A and 2B.

FIG. 3 is a front view of a flower pot according to the prior art formed from a straight vacuum forming process having a distorted design on the outer surface of the flower pot.

FIG. 4A is a perspective view of an embossed flower pot formed by straight vacuum forming according to present invention.

FIG. 4B is a perspective view of an embossed decorative wrapper that is bonded to at least a portion of the outer peripheral surface of the flower pot shown in FIG. 4A.

FIG. 5A is a front elevation view of a decorative flower pot having a decorative wrapper bonded to a vacuum formed flower pot according to the invention of FIGS. 4A and 4B.

FIG. 5B is a rear elevation view of the decorative flower pot of FIG. 5A.

FIG. 6 is a front perspective view of a decorative flower pot formed by straight vacuum molding, the decoration being undistorted by the vacuum forming process according to the present invention.

FIG. 7 is a front view of a sheet of plastic material used to form a flower pot according to the present invention, the design imprinted on the sheet being pre-distorted to compensate for the distortion incurred during the vacuum forming process.

FIG. 8 is front view of a radial grid imprinted on a clear plastic sheet which, when vacuum formed into a flower pot according to the present invention, serves as a template for creating a compressed image of a desired design.

FIG. 9 is a perspective view of the template of FIG. 8 being used to determine the color coordinates of a design printed on a flower pot that is to be copied.

Similar reference characters denote corresponding features consistently throughout the attached drawings.

### DETAILED DESCRIPTION OF THE PREFERRED EMBODIMENTS

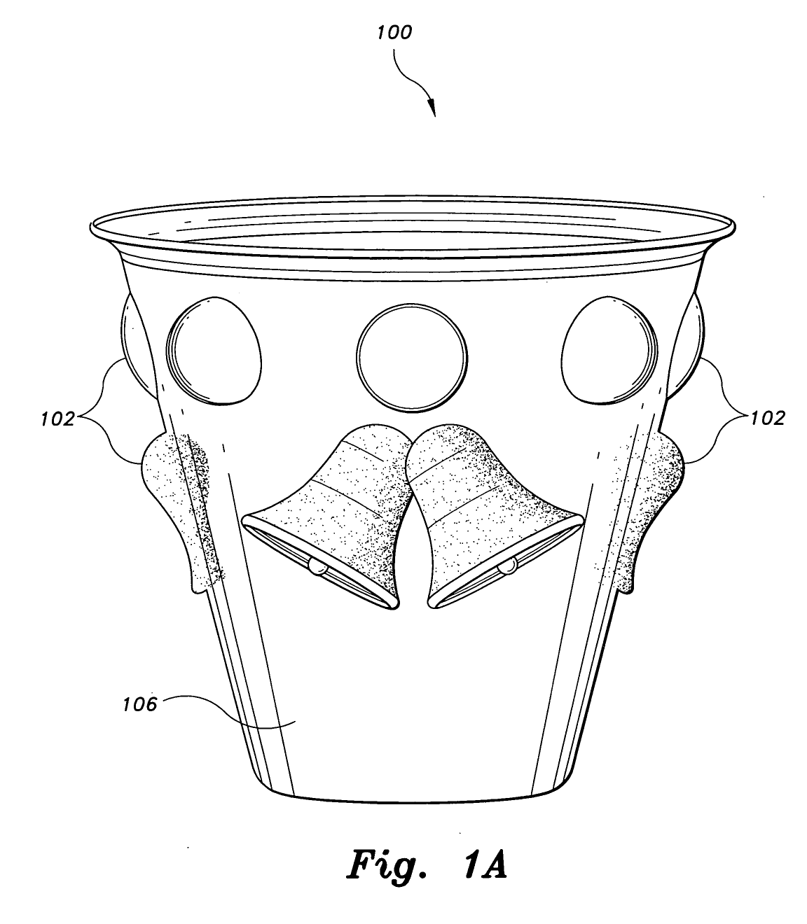

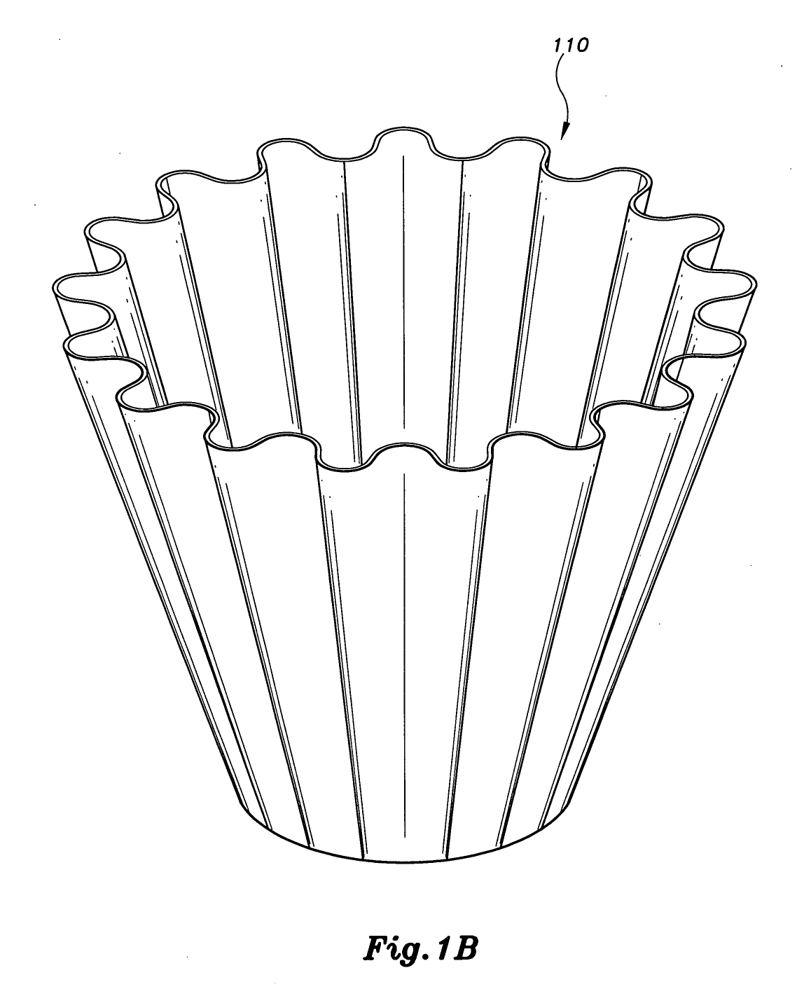

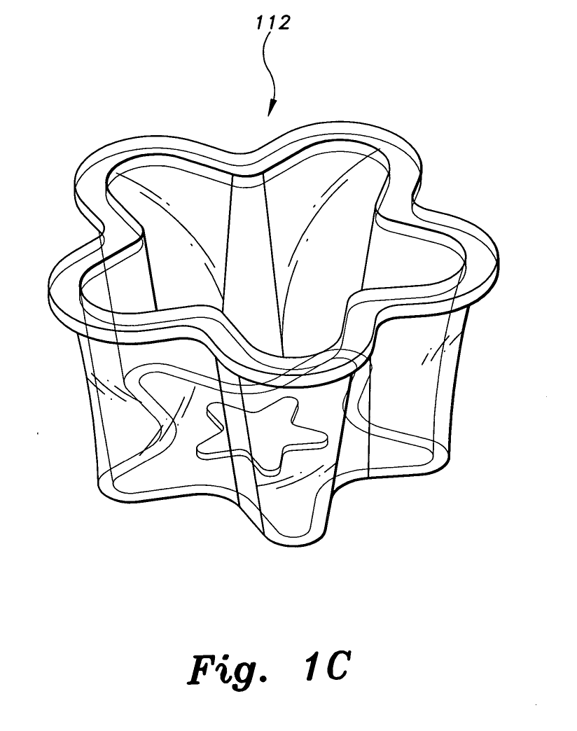

The present invention is a method for forming a decorative flower pot, and particularly forming a decoration on the outer peripheral surface of the flower pot. As shown in FIG. 1A, a first embodiment of the method forms a decorative embossed pattern 102 on the outer peripheral surface 106 of a plastic flower pot 100. The embossed pattern 102 may be any of a number of patterns, such as depictions of flowers, balls, bells, or any spaced apart raised portions in the outer peripheral surface 106 of the flower pot 100, and a corresponding depressed portion on the inner peripheral surface of the flower pot 100. The flower pot 100 with an embossed design 102 provides more rigidity as compared to an unembossed flower pot. A flower pot having a number of sides, corners, and contours provides not only a more atheistically pleasing flower pot, but one having greater structural integrity, as exemplified by the scalloped flower pot 110 and star shaped flower pot 112 in FIGS. 1B-1C,

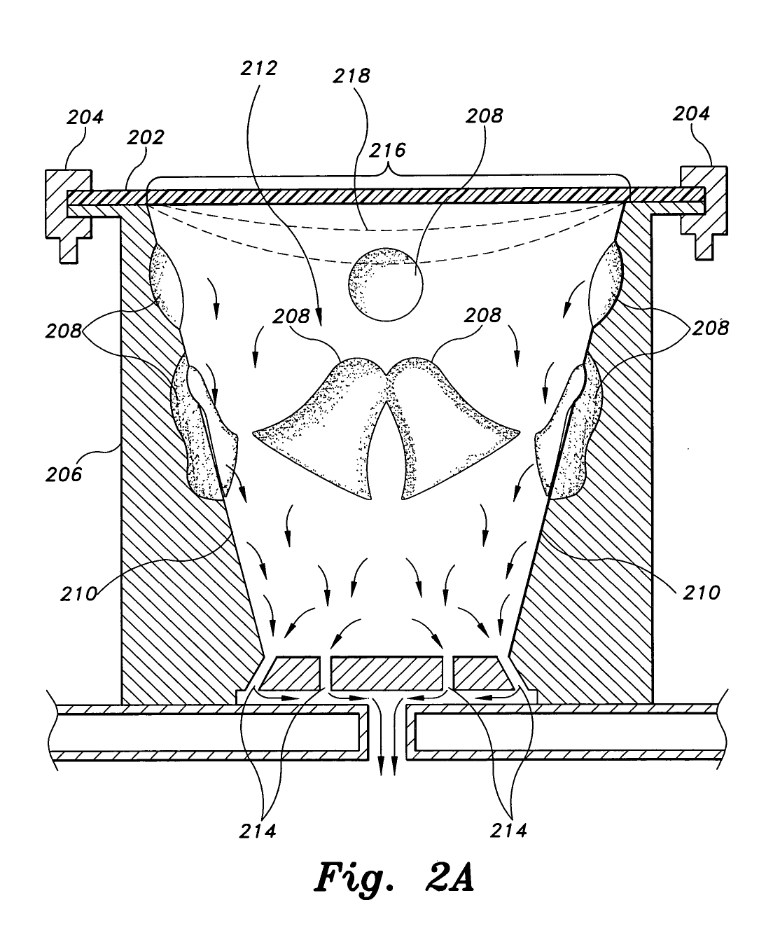

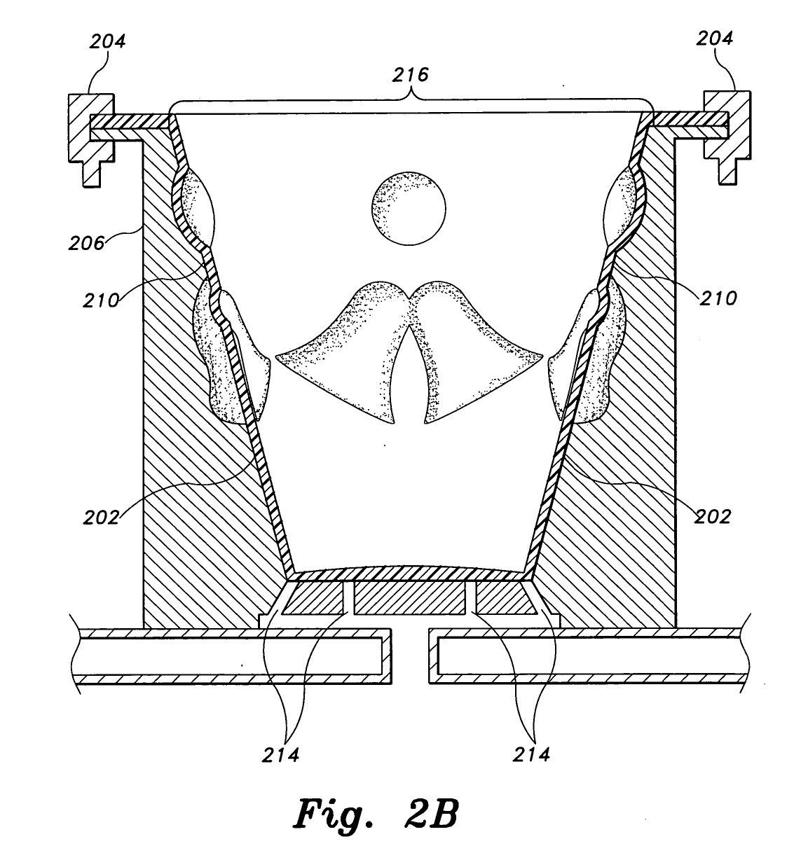

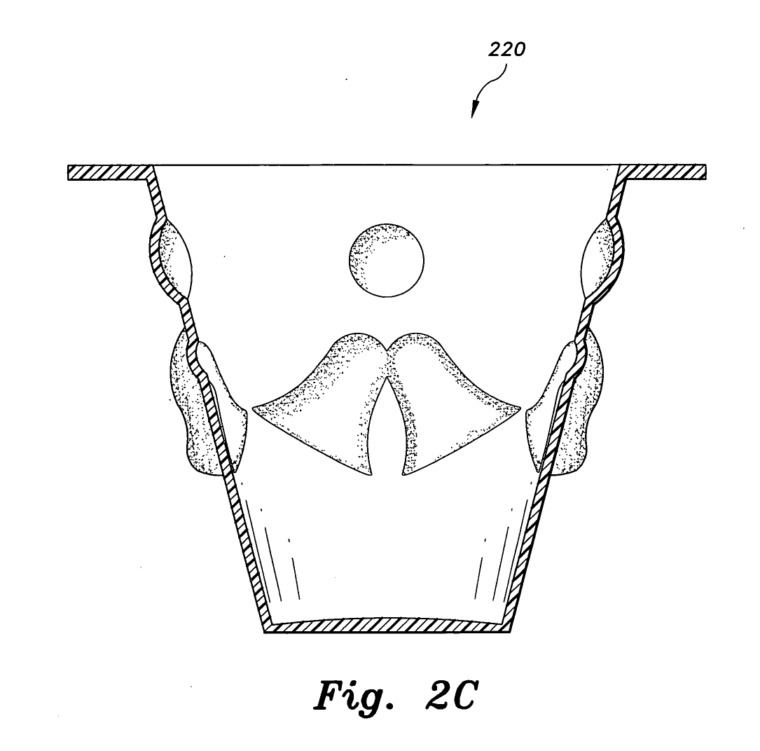

The flower pot 100 and the embossed pattern 102 disposed thereon are formed by straight vacuum forming, as shown in FIGS. 2A-2C. In the straight vacuum forming process shown, a plastic sheet 202 is clamped in a frame 204 and heated. While the hot sheet 202 is rubbery, or in an elastic state, it is placed over a female mold 206, the walls 210 of which correspond to the outer peripheral surface of the flower pot 100, as shown in FIG. 2A. A desired embossed design 208 is formed in the walls 210 and contours of the mold 206. Air is removed from the mold cavity 212 by a vacuum from a pump or other source (not shown) applied through slots 214, and atmospheric pressure forces the hot sheet 202 against the walls 210 of mold 206, as shown in FIG. 2B. When the plastic has cooled, the formed pot 220 is removed, as shown in FIG. 2C, and final finishing and decoration may be done. The final finishing may include, e.g., imprinting a design on the outer peripheral surface of the flower pot using a rotational offset printing process.

The plastic sheet 202 may be a flat sheet 202 of polyvinyl chloride, or any sheet of a suitable plastic material including, but not limited to, polyethylene (PE), polyethylene terephthalate (PET), and ethylene-vinyl acetate (EVA).

The flower pots are best formed by quickly applying the vacuum before any portion of the sheet 202 has cooled. Slots 214 should be placed in all low or unconnected portions of the mold to eliminate any air that may be trapped under the hot sheet 202. A suitable angle is included in the walls 210 for easy removal of the finished flower pot 220.

The thickness of the plastic sheet 202 is normally less than 1 mm, preferably ranging from about 0.4 mm to 0.9 mm. Although the normal depth of the flower pots produced are less than seven inches in diameter and seven inches in depth, larger pots up to fifteen inches are possible.

The draw, or draw ratio, of the mold 206 is the ratio of the maximum cavity depth to the minimum span across the top opening 216. For high density polyethylene (PE), the best results are achieved when this ratio does not exceed 0.7:1, although good results are obtained when making a 4-inch flower pot made from polyvinyl chloride (PVC) and a draw of 1:1. Straight vacuum forming is known in the art of thermoforming equipment, and dies are relatively inexpensive.

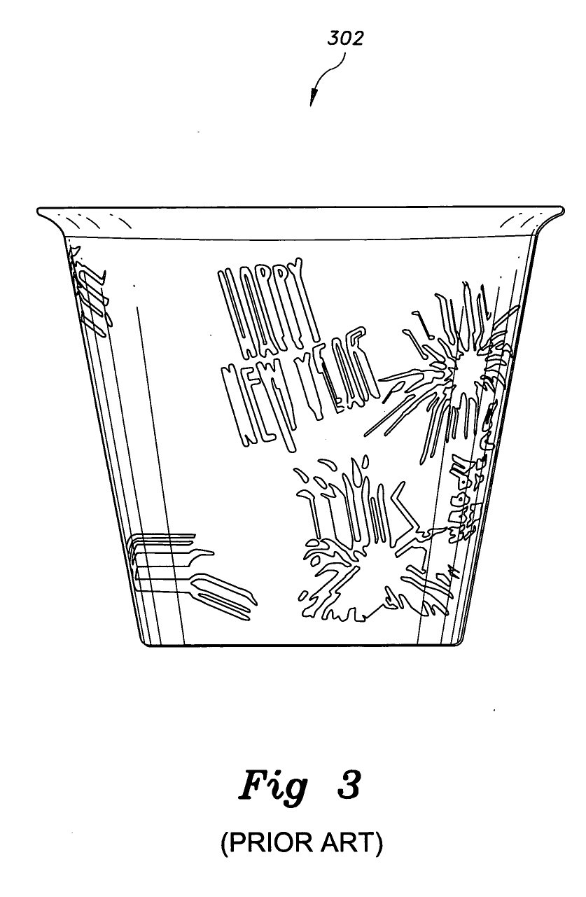

The placement of a decorative design on the plastic sheet 202 prior to vacuum forming can lead to a distorted design on a flower pot 302, as shown in the prior art view of FIG. 3. Thinning, stretching, and general distortion of the design is caused by the hot plastic sheet 202 first being drawn to the center 218 of the mold 206. Sheeting at the edges of the mold 206 must stretch the most and thus becomes the thinnest portion of the formed item. A second embodiment of the present invention, described below, avoids the distortion caused by thinning of the plastic sheet 202, and a third embodiment, also described below, discloses a method for compensating for distortion during forming.

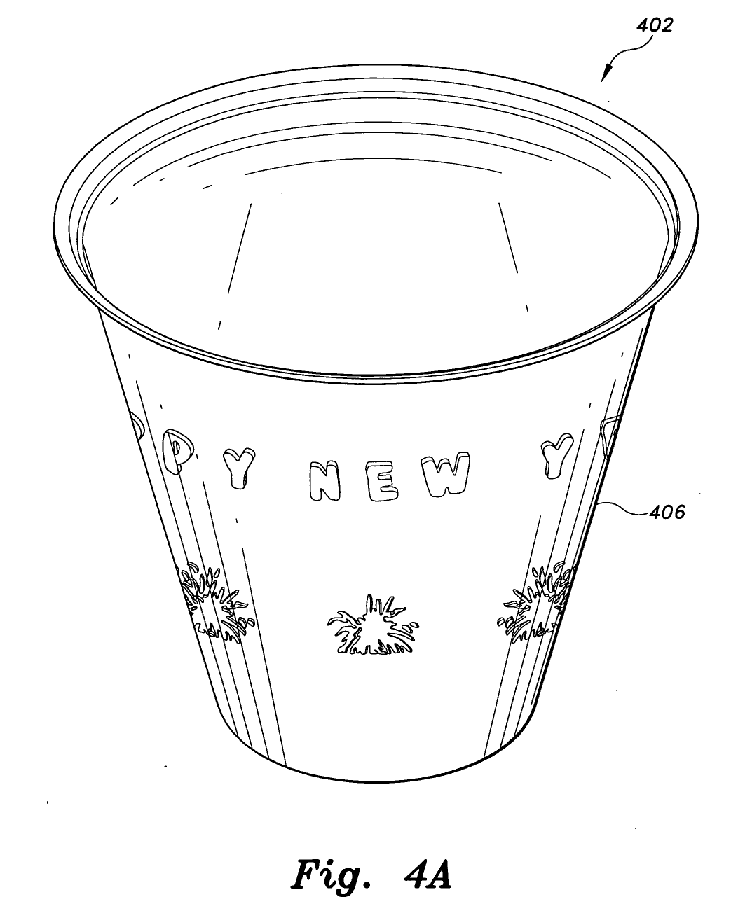

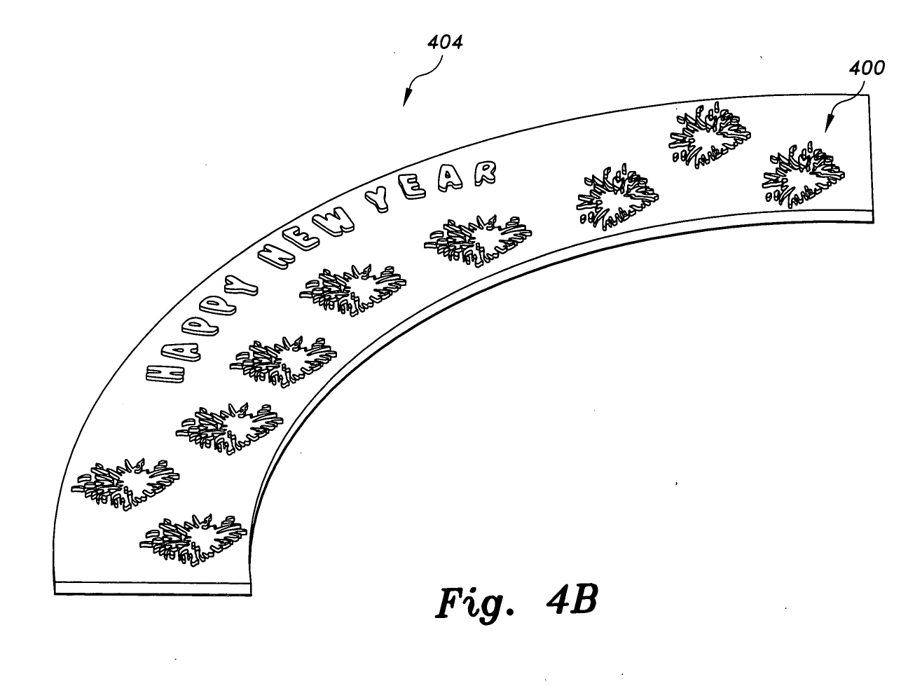

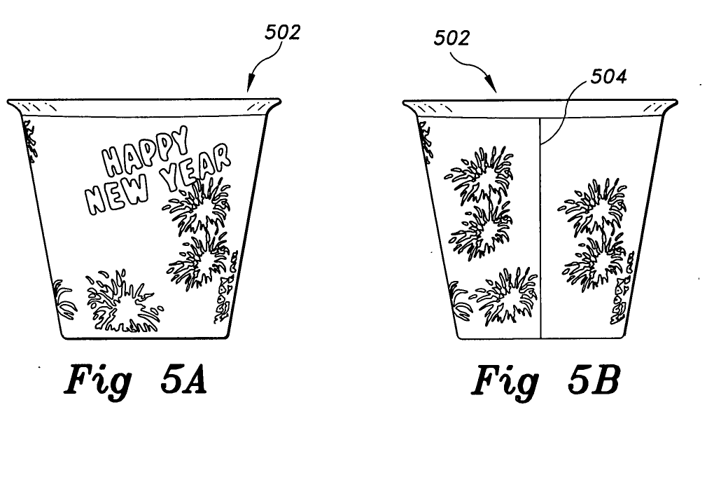

FIG. 4A illustrates a vacuum formed flower pot 402 having an embossed design 406 over which a decorative wrapper 404, shown in FIG. 4B, is wrapped to create a distortion free design disposed on the outer peripheral surface 406 of flower pot 402. The flower pot 402 is molded using straight vacuum forming as previously disclosed. Although the flower pot may have a smooth outer peripheral surface 406, a preferred design would incorporate a flower pot 402 having an embossed design and a wrapper 404 covering at least a portion of the outer peripheral surface 406 of the flower pot 402. The wrapper 404 has the identical embossed design 400 on its outer surface as the flower pot, and when overlaid the flower pot 406, the patterns on the flower pot 402 and wrapper 404 advantageously engage, not only providing a more aesthetically appealing flower pot, but also increasing the bonding surface, thereby preventing the wrapper 404 from shifting on the surface of the flower pot 402. A bonding material, such as a conventional adhesive, is applied to the inner surface of the wrapper 404 and bonds the wrapper 404 to the outer peripheral surface of the flower pot 402. As illustrated in FIG. 5A, the resultant flower pot 502 has an undistorted decoration visible on the front of the flower pot. FIG. 5B illustrates the rear of the flower pot 502, showing the exaggerated seam 504 formed by the ends of the wrapper 404.

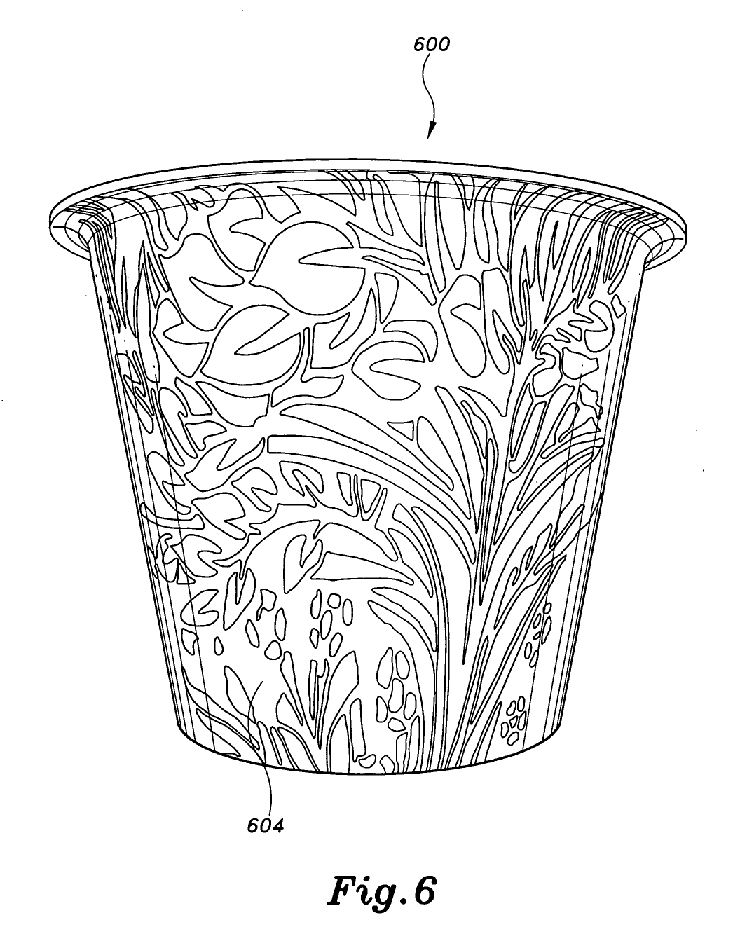

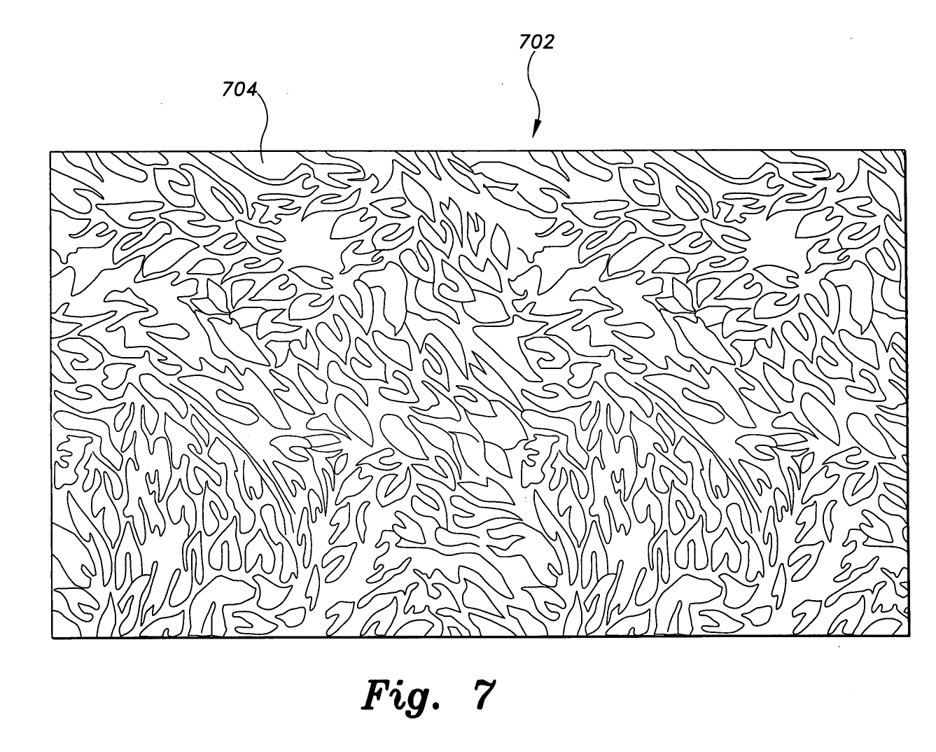

An alternative embodiment which creates a flower pot with an undistorted design on its outer peripheral surface involves compensating for distortion of the design during vacuum forming. This method entails printing a compressed, or pre-distorted design 704, on the plastic sheet 702 prior to vacuum forming. As shown in FIG. 6 flower pot 600 is vacuum formed using the plastic sheet 702 shown in FIG. 7. As can be seen from FIG. 7, the compressed design 704 bears minimal relation to the design 604 on the outer peripheral surface of the flower pot 600. Pre-distorting the desired finished design compensates for the stretching and thinning of the vacuum forming process.

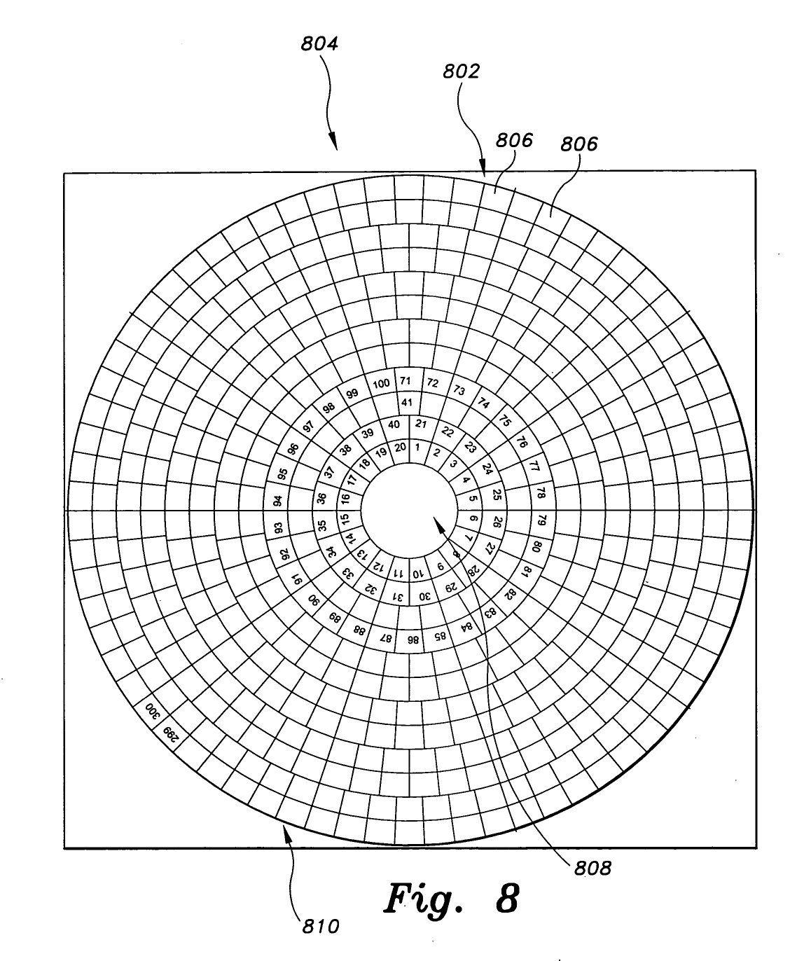

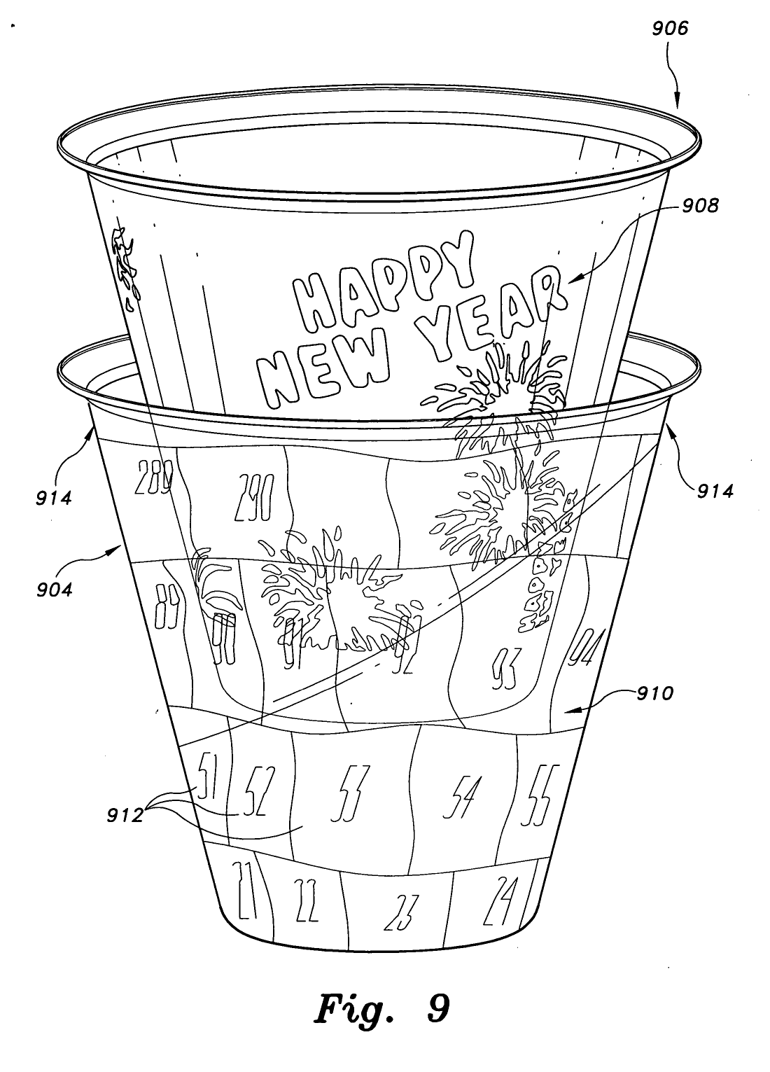

Pre-distorting the image can be achieved by trial and error, or can be accomplished by the following distortion mapping process described in conjunction with FIGS. 8 and 9.

This third method starts with a flower pot 906 on which a desired image 908 is disposed. This may be accomplished by several means, including the wrapper method previously disclosed, or by simply drawing the desired image on the outer peripheral surface of an otherwise blank flower pot.

The key to this method is the creation of flower pot template 904, into which a flower pot 906, having the desired image 908, is inserted. Template 904 is formed by vacuum forming a sheet of clear plastic 804, the sheet having a radial matrix 802 formed on the lower surface of the sheet 804. The radial matrix 802 has a multitude of numerically or otherwise identifiable sections 806 which, when stretched by the vacuum forming process previously disclosed, produces a clear flower pot having a stretched and distorted grid 910 disposed on its outer surface. The portion of the plastic sheet 804 on which the center 808 of the radial matrix is formed becomes the bottom of the template flower pot 904, and the grid sections corresponding to the matrix's outer periphery 810 form the upper section 914 of the formed template 904. The individual grid sections 806 comprising the radial matrix 802 must be small enough to adequately map the desired design into a color coordinate matrix. Although for relatively noncomplex designs, the grid sections 806 would be approximately 1/4 of an inch square, the more intricate the desired design, the tighter the matrix 802 must be. The size of each grid section 912 in the stretched and deformed matrix shown in FIG. 9 is exaggerated for the sake of this disclosure.

The purpose of creating this template having a deformed grid 910 is to overlay the desired image 908 with a clear grid which can be used to determine what each section of a plastic sheet must be colored in order to form a flower pot having an undistorted design once the sheet is vacuum formed.

Flower pot 906, having the desired image 908, is inserted into the template 904 and the color of each distorted grid section 912 is recorded and is used to color the appropriate section of a plastic sheet subsequently used to form a finished product. Once the design has been transferred to a plastic sheet, the sheet can be vacuum formed into a flower pot having a relatively undistorted design disposed on it outer surface.

Given the fact that variations in distortion cannot be controlled completely, the template must be made as identical to the final product as possible, using a plastic sheet having the same characteristics as the finished product to best reproduce the distortion process the production version of the flower pot will experience.

It is further understood that the present invention is not limited to the embodiments described above, but encompasses any and all embodiments within the scope of the following claims.

1. A method of manufacturing a decorative flower pot having an outer peripheral surface with embossed decorations, comprising the steps of:
forming a female mold cavity of a flower pot, the mold cavity having walls and contours disposed on said walls, said contours corresponding to a desired embossed design; and
vacuum forming a plastic flower pot in the mold, the flower pot having embossed decorations on the outer peripheral surface of the flower pot.

2. A decorative flower pot produced according to the method of claim 1.

3. The method of claim 1, further comprising the steps of clamping a plastic sheet in a frame and heating said plastic sheet.

4. The method of claim 3, further comprising the step of placing said plastic sheet and frame over said female mold cavity while said sheet is in an elastic state.

5. The method of claim 1, further comprising the step of imprinting a design on the outer peripheral surface of said flower pot using a rotational offset printing process.

6. The method of claim 1, wherein the vacuum forming step further comprises the step of removing air from said mold cavity by applying a vacuum in order to force the heated plastic sheet against the walls and contours of said mold cavity, thereby forming a plastic flower pot having an embossed design on the outer peripheral surface of said flower pot.

7. The method of claim 1, further comprising the steps of:
forming an embossed wrapper having an inner surface and a decorative outer surface, the embossed design on said wrapper being substantially identical to the embossed decorations on the outer peripheral surface of said flower pot so that said wrapper engages the embossed design on said flower pot when wrapped around said flower pot; and
bonding the inner surface of said wrapper to at least a portion of the outer peripheral surface of said flower pot;
whereby said flower pot has a decorative design embossed on the outer peripheral surface of said flower pot undistorted by the vacuum forming process.

8. A decorative flower pot produced according to the method of claim 7.

9. The method of claim 1, further comprising the step of vacuum forming a plastic flower pot having a plurality of sides and contours.

10. A method of providing a flower pot with a decorative exterior, comprising the steps of:
vacuum forming a plastic flower pot having an outer peripheral surface;
forming a wrapper having an inner surface and a decorative outer surface; and
bonding the inner surface of said wrapper to at least a portion of the outer peripheral surface of said flower pot;
whereby a decorative flower pot is formed, said flower pot having a decorative design disposed on the outer peripheral surface of said flower pot, the design being undistorted by the vacuum forming process.

11. The method of claim 10, wherein the step of vacuum forming includes forming an embossed design on the outer peripheral surface of said flower pot.

12. The method of claim 11, further comprising the step of embossing a design on at least a portion of the outer surface of said wrapper.

13. The method of claim 10, further comprising wherein the step of vacuum includes forming a plurality of sides and contours in the flower pot.

14. A decorative flower pot produced according to the method of claim 10.

15. A method of forming a flower pot having an undistorted image disposed on the outer peripheral surface of the flower pot, comprising the steps of:
providing a plastic sheet having an upper surface and a lower surface;
forming a compressed image on at least a portion of the lower surface of said plastic sheet, the image being a visually distorted representation of a desired pattern;
clamping said plastic sheet in a frame;
heating said plastic sheet;
placing said plastic sheet and frame over said female mold cavity while said sheet is in an elastic state; and
removing the air from said mold cavity by a vacuum process, forcing the heated plastic sheet against the walls and contours of said mold cavity;
whereby a plastic flower pot is formed having an undistorted image of a desired pattern on the outer peripheral surface of said flower pot.

16. A decorative flower pot produced according to the method of claim 15.

17. The method of claim 15, wherein said step of forming a compressed image on at least a portion of the lower surface of said plastic sheet further comprises the step of compensating for the distortion undergone by said plastic sheet when stretched by said vacuum process.

18. The method of claim 15, further comprising the steps of:
imprinting a grid on a plastic template sheet, said grid having a multitude of identifiable sections; and
vacuum forming a flower pot template using said grid imprinted template sheet, said grid being distorted by said vacuum forming.

19. The method of claim 18, further comprising the steps of:
overlaying said template over a flower pot having a desired pattern disposed thereon;
determining each grid section color imprinted on said template; and
transposing the color of each distorted grid section on said template to a second and subsequent plastic sheet;
whereby a compressed image on at least a portion of a lower surface of said second plastic sheet is formed.
